(19) United States
(12) Patent Application Publication
(10) Pub. No.: US 2016/0234234 A1
(43) Pub. Date: Aug. 11, 2016

(54) Orchestrating the Use of Network Resources in Software Defined Networking Applications

(71) Applicant: Cisco Technology, Inc., San Jose, CA (US)

(72) Inventors: David McGrew, Poolesville, MD (US); Kenneth S. Beck, Morgan Hill, CA (US)

(21) Appl. No.: 14/614,530

(22) Filed: Feb. 5, 2015

(51) Int. Cl. H04L 29/06

(52) U.S. Cl. CPC H04L 63/1425; H04L 63/18; H04L 63/20

(57) ABSTRACT

Techniques are presented herein that allow for arranging traffic flows in a network, and using the capabilities for inspection, recording, and enforcement around the network, in a way that makes the best use of the resources. A software defined network (SDN) interface between the network and security applications exposes a programmatic way to control security resources around the network such that they are optimally utilized. The SDN interface prioritizes and optimizes the use of security elements in the network. Security requests with corresponding priorities are used by a network controller to direct traffic flows through appropriate security elements, such as recording, inspection, or enforcement elements. The configuration of traffic flows is optimized with respect to the capacity of the communication links, as well as the priority of the respective security requests.

### TECHNICAL FIELD

The present disclosure relates generally to optimizing use of security resources in software defined networks.

### BACKGROUND

A communication network may be modeled as a directed graph in which the exterior nodes are sources and sinks of data flows, the interior nodes are routers or switches, and each edge corresponds to a data link. Each edge is typically associated with a capacity (e.g., a maximum throughput). A cost can be assigned to an edge or node, which represents the cost of transmitting one unit of data through it. In minimum-cost routing, the sum of the costs over the entire network is minimized, for a given set of data flows between sources and sinks, by assigning flows to edges in a way that keeps the total flow of each edge below capacity, while minimizing the linear sum of the costs. More general models are possible, in which the cost is a nonlinear function of traffic. Alternatively, a single central processing unit (CPU) can run multiple security processes at the same time by adaptive scanning. If the efficacy of different inspection processes on different types of traffic is known, one can optimize the overall efficacy of the inspection of aggregated traffic.

### BRIEF DESCRIPTION OF THE DRAWINGS

FIG. 1 shows a network element that includes a security element, according to an example embodiment.

FIG. 2 is a block diagram of a network controller that orchestrates the assignment of network paths to communication flows, according to an example embodiment.

FIG. 3 shows a communication network with switches, routers, and endpoints in which the techniques presented herein may be employed, according to an example embodiment.

FIG. 4 shows a software defined network including a recording network element and an inspection network element, according to an example embodiment.

FIG. 5 shows an example embodiment in which a traffic flow is routed through a network element with an inspection capability.

FIG. 6 shows an example embodiment in which a traffic flow is routed through a network element with a recording capability.

FIG. 7 shows an example embodiment of prioritized-based processing of security requests to be satisfied by a software defined network.

FIG. 8 shows another example embodiment of a communication network with switches, routers, sources, and sinks in which the techniques presented herein may be employed.

FIG. 9 shows a process for assigning network paths to communication flows, according to an example embodiment.

### DESCRIPTION OF EXAMPLE EMBODIMENTS

### Overview

Techniques are presented herein that allow for arranging traffic flows in a network, and using the capabilities for inspection, recording, and enforcement around the network, in a way that makes the best use of the resources. A software defined network (SDN) interface between the network and security applications exposes a programmatic way to control security resources around the network such that they are optimally utilized. The SDN interface prioritizes and optimizes the use of security elements in the network. Security requests with corresponding priorities are used by a network controller to direct traffic flows through appropriate security elements, such as recording, inspection, or enforcement elements. The configuration of traffic flows is optimized with respect to the capacity of the communication links, as well as the priority of the respective security requests.

### Description of Example Embodiments

A network may contain multiple security elements on a network, each of which performs a security function like monitoring (e.g., Netflow export, Deep Packet Inspection, Network Based Application Recognition) or enforcement (e.g., Network Firewall, Application Firewall). In some cases, these functions are provided by software or by virtual machines. Each security element has particular capacity for performing its function. One way to model that capacity is to consider the maximum rate at which the security element can process data. For example, a particular firewall may be able to process HyperText Transfer Protocol (HTTP) traffic at 2 Gigabits per second. In other models, there can be other considerations such as the central processing unit (CPU) utilization required to process traffic at a particular rate, or the amount of state required to process traffic. Many firewalls have a fixed upper limit on the number of Transmission Control Protocol (TCP) sessions and/or HTTP sessions that they can inspect or proxy, for instance, because each session consumes some of the fast random access memory (RAM) that is available.

Security services can be broadly categorized as enforcement, to actively block or potentially alter traffic for conformance, and inspection, which passively observes traffic without blocking or altering it. Selected flows can be redirected so that they pass through a network element that provides enforcement or inspection, and selected flows can be copied and sent to an inspection engine. Firewalls and Distributed Denial-of-Service (DDoS) scrubbers provide enforcement, while IPS and Netflow services are examples of inspection.

Software Defined Networking (SDN) allows programmatic access to network functionality. An SDN system that is aware of the security elements on a network can provide a programmatic interface to the security functionality on the network. For instance, the interface could be used to request that all traffic to and from a particular device be monitored. The SDN system can arrange the flow of traffic through the network so that the monitoring takes place. The system will need to handle many simultaneous requests, typically.

It may not be possible for the system to monitor all of the traffic that needs to be monitored. In order to make the best use of the monitoring resources on the network, each flow that is to be monitored can be associated with a numeric priority, such as the probability that monitoring the flow will result in the detection of an important event. Threat Defense provides a good motivating example; it aims to detect network flows that originate from malware. In an SDN system that manages security elements, each request to monitor traffic should specify the priority of that request. Below a definition is presented for the priority that can be used by the system to achieve optimal use of the security elements.

A data network typically determines how traffic is forwarded using a routing algorithm such as Open Shortest Path First, or using a least-cost method that aims to substantially minimize a metric associated with the assignment of traffic to links on the network. The data network is modeled as a flow network, that is, a directed graph in which each edge is associated with a capacity, each internal node represents a router or switch, and each terminal node is a network endpoint that acts as a source or sink of data. A flow has a particular data rate, starts at a data source and ends at a data sink. One useful metric associates, with each link in a network, a cost to sending a bit of data across that link; the overall cost is the sum of the costs over all of the links. Given a set of flows, the routing system can select an assignment of data flows to edges that substantially minimizes the overall cost, assuming that the set of flows does not exceed the capacity of the network.

A conventional “transport network” model contains link capacities, but does not capture the inspection or enforcement capabilities that would be desirable to associate with network elements. To accommodate these capabilities in the model, an augmented graph is defined that contains the same edges as the network graph, but which also splits each security-capable node into two nodes connected by an edge. The center edge is associated with the capacity of the security element. In this way, the conventional graph model of a network also models the capacity of the security resources in the network.

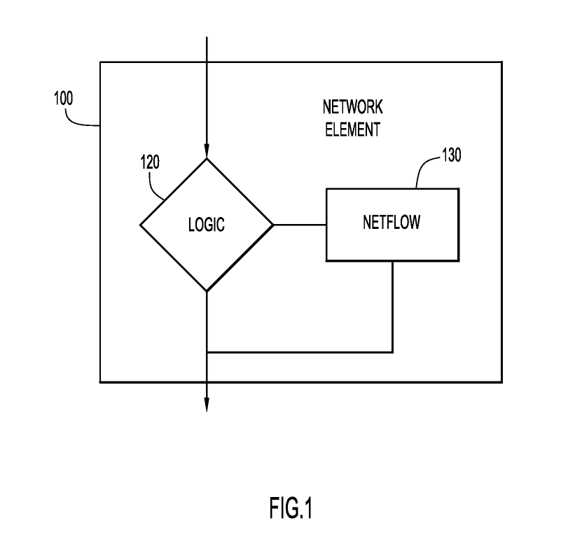

Referring now to FIG. 1, a block diagram of a network security element 100 (network element) is shown. The network element 100 includes logic 120 to handle communication flows through the network element 100. Additionally, the network element 100 may include a module 130 to provide a service on the communication flows that pass through network element 100. In one example, the module 130 provides a monitoring/inspection service, such as a Netflow exporter. In another example, the module 130 may provide a security enforcement service or a recording service.

The network element 100 may be represented in a simple model by an edge with a capacity equal to the rate at which traffic can flow through it. From the point of view of the security resources used on the network, there is a flow network representing the connections between sources, sinks, and security elements. This flow network captures the ability of the network to provide security services.

SDN applications can request the inspection of certain traffic, but the available security resources may not have the capacity to inspect all of that traffic. To solve this problem, an interface to the SDN system associates each request to inspect traffic with a priority value. For instance, the priority can be a number, with higher numbers representing higher priorities. In one example, the priority could indicate the likelihood that inspecting the traffic will result in the discovery of evidence of malicious activity. The SDN system orchestrates the flow of traffic, and the use of inspection elements, to maximize the sum of the priority values of the inspection requests that are satisfied. If the priority value associated with the inspection requests is equal to the likelihood of detecting malicious activity, for instance, then substantially maximizing the sum of priority values optimizes the expected number of detection events.

One example to substantially maximize the priority defines the cost associated with a particular assignment of flows to edges C as Pmax−P, where P is the sum of the priorities of all inspected flows, and Pmax is the maximum possible value that P can have. This allows for the definition of a minimum-cost Netflow flow assignment problem with the edge capacities and the cost C. This problem can be solved in any of several ways, including the Ford-Fulkerson algorithm or network simplex algorithm.

Another example of a priority definition is as follows. A request to inspect a particular flow may result in the discovery of some malicious activity. The system may aim to maximize the probability that this discovery occurs. Thus, the system may base the priority associated with a flow-monitoring request on the probability P that, if the request is granted, it will lead to a useful discovery. Since these probabilities will often be quite small, e.g., approximately 10⁻¹⁰, it is convenient to define the priority to be −log(P). Then the highest probability event has a priority of zero, which corresponds to a certain discovery, and higher numerical priority values correspond to less likely discovery, with the probabilities decreasing rapidly as the priority increases. For example, if P=10⁻¹⁰ then the priority will be 10. To maximize the probability that the monitoring and inspection will be effective, the SDN system may aim to maximize the sum of the probabilities associated with the flow-monitoring requests that are satisfied. This sum can easily be computed from the priorities as defined above.

The concept of priority is especially useful for monitoring and inspection requests, but it can also be used for other security services. When a firewall service is requested, the requesting application may set the priority value to zero in order to indicate that the request is not considered optional.

In an SDN system, the network controller contains a model representing the topology of the network; it is said to have topological awareness. In order to make effective use of the security elements in the network, it is not necessary to have all of this awareness, since the parts of the network without any security capabilities are irrelevant to the security element utilization problem. In another example, a separate security component could use the controller's API to identify the “security topology”, that is, the network flow model in which there are only sources, sinks, and security nodes, and other internal nodes (routers and switches) have been logically collapsed away. The security component can solve the network security element utilization problem, and then use the network controller API to appropriately direct traffic flows.

It is a non-trivial task to compute the priority that should be associated with a flow-inspection request. However, it is tractable to estimate these values, and they could be computed by a Threat Analysis (TA) system. In practice, these priorities will be estimates, and they may be dynamically updated as new information becomes available.

The SDN system is faced with the following optimization problem: it seeks to maximize the sum of the probabilities associated with the flow-monitoring requests that are satisfied, while also respecting other constrains such as the sum of the data rates of each flow that traverse a given network link must be less than the capacity of that link. The following approach can be used; it uses as a subroutine a method for assigning flows to paths in the network which does not take flow-monitoring requests into consideration. First, the monitoring requests are sorted into increasing priority order (and thus decreasing probability order). Then for each of those requests, the flow(s) associated with the requests are assigned to a path in the network, in increasing priority order. After all of the requests have been processed in this way, the other flows in the network are assigned to paths.

If the security capabilities on a network are not entirely used up, and all requests for inspection have been satisfied, then the system will select traffic to be inspected using some pre-established criteria. One option is to select traffic at random. Another is to select traffic for inspection by protocol type.

One way to model a communications network is as a directed graph with an edge set E and a vertex set V. Each vertex represents a network element, and an edge represents a communication link between two such elements. A flow can be modeled as a source x, a sink y, which we denote as [x, y]. Each flow is associated with a data rate. A path through the network is an ordered list of edges that start at a source and end at a sink, which we denote as (x, a, b, . . . , y), for a path for flow [x, y]. Here a, b, x, and y are all vertexes in V.

The network model will often associate a weight with each edge. A weight may be a number that represents the cost associated with using that edge as a communications link. The cost associated with a path is the sum of the weights of the edges in the path. If the weights are all equal to one, for instance, then the cost of a path is the number of communication links in that path. Weights can also be chosen to represent other link characteristics, such as bandwidth. The Open Shortest Path First (OSPF) routing protocol, for instance, sets the weight associated with a link as being inversely proportional to the bandwidth of the link. There are other methods for assigning weights to links as well.

A network controller may install forwarding rules into network elements that inform those devices how different flows should be forwarded. For instance, in the OpenFlow model, when an endpoint initiates a new flow, the network element that receives this flow queries the network controller to find out how the flow should be forwarded. Conventionally, the network controller installs forwarding rules based on performance considerations such as the overall latency, which is minimized when the number of edges in the flow is minimized. Another consideration is that each of the edges in the network generally must have a capacity that is at least as large as the sum of the data rates of each flow that traverses that edge.

To determine the lowest-cost path for a flow, a network controller can use an algorithm that solves the all-pairs shortest path problem, which takes as input a network graph and finds the path between each pair of elements with the lowest cost. A network controller can compute the lowest cost paths between each of the network elements that it controls, and then when it needs to assign a path to a flow, it consults this data to see which path is best.

To incorporate network security, certain flows are selected to have security services applied to them. When the network controller selects a path for one of these flows, it chooses a service path that traverses a network element that can provide the appropriate security service. That path can also be chosen to optimize characteristics such as latency, to the extent that it is possible to do so while still traversing a network element that can provide the needed security service. The network controller defines the lowest cost service path for a flow [x, y] as the path from x to y with the fewest number of edges that traverses at least one node that can provide the service. In this context, a service may involve inspection, recording of traffic, Netflow/IP Flow Information Export (IPFIX) generation, or policy enforcement via a firewall, and so on. It is possible to compute the shortest service path between one source element and all other elements as follows. A network element that can perform a particular service is called a service element. Given a graph that represents a network, in which some of the network elements are service elements, the distances between each of the service elements each of the other elements is computed. To simplify the explanation, the service set is denoted as S, and the path cost (also called the distance) between two elements x and y is denoted as D(x, y). Then the shortest service path for a flow [x, y] with a set S of service elements is the service path that consists of the shortest path from x to s concatenated with the shortest path from s to y, where s is chosen from all of the elements in S such that D(x, s)+D(s, y) is less than or equal to D(x, z)+D(z, y) for all z in S.

There are many different techniques for finding suitable paths for flows, and the network controller can apply these techniques to each half of the path (x, . . . , s, . . . y) when addressing the problem of finding a suitable service path for the flow [x, y].

Inspection, monitoring, and recording are all useful security services, and they can all be applied to a copy of a network flow, instead of to the original flow itself. A network element can make a copy of selected flows and forward that copy to a device that performs the inspection, monitoring, or recording. This may be done with techniques such as port mirroring or a Test Access Point (TAP). In an SDN system, it is desirable to control where the copying is done and where the inspection, monitoring, or recording is done. Because the copying of the data creates a new flow on the network, there are different considerations that those described above when those security services are performed on the actual path of the flow. When providing a service on a flow [x, y] by copying that flow to a network element that offers that service, in addition to the service path (x, . . . , c, . . . , y), where c denotes the node that copies the flow, there is another path (c, . . . , s) between the copy-node and the node that provides the service. Thus, when assigning a path to a flow [x, y], the controller seeks to minimize the value D(x, c)+D(c, y)+D(c, s), where c is in the set of copy nodes and s is in the set of service nodes. This can be done as above. The values of D(c, s) can be computed and stored for all of each copy node c and each service node s. The value D(c, s) then corresponds to an extra cost associated with c.

In one example, the security elements themselves are unaware of the system that is directing traffic through them. That is, the system can redirect traffic flows to devices such as firewalls, Intrusion Detection/Protection Systems (IDS/IPS), and Netflow exporters, without those devices being aware that traffic is being routed in such a way as to utilize the services that they provide. The system is able to work with these “unaware” devices, to increase the number of security devices that can be used in the system. However, the system may also have a way that it can import information about security elements. In one example, this would contain a network or service discovery mechanism (e.g., the Cisco OnePK, pxGrid discovery mechanisms, or the multicast Domain Name System (mDNS) discovery system).

The description above is specific to the inspection of traffic, such as Intrusion Detection/Protection Systems (IDS/IPS) or flow-based monitoring (Netflow exporters). However, the system described above can be used to orchestrate the security enforcement capabilities in the network, such as the use of firewalls or application proxies/gateways. In the enforcement case, if there is not enough enforcement capacity in the network it may be desirable to drop traffic rather than to allow it to pass through the network without undergoing conformance checking. In an SDN context, it may still be useful to have a priority associated with an enforcement request, but there should be a way to indicate that the enforcement is mandatory; for example, the security application could be able to indicate via a flag in the API that, if there is not sufficient capacity to comply with a request for enforcement on a particular traffic flow, then the traffic flow should not be allowed to pass.

An SDN system can be integrated with a Virtual Machine (VM) management system in a way that allows the system to orchestrate computing resources as well as network resources. Such a combined system can dynamically create new VMs and route traffic to them as appropriate. The API presented to the SDN security application could handle requests for enforcement and inspection by automatically creating new VMs and shutting down old VMs so that the computing node has the appropriate capabilities, or by changing the priority with which the software on the system runs (e.g., the Portable Operating System Interface (POSIX) “nice” priority).

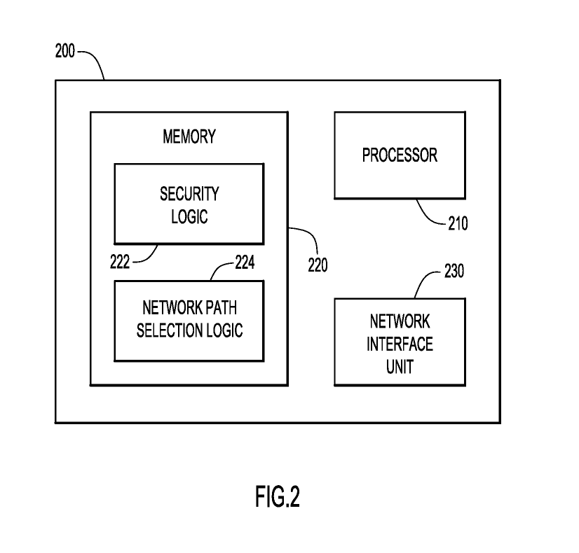

Referring now to FIG. 2, a block diagram shows an example of a network controller 200 that can orchestrate the assignment of network paths to communication flows according to embodiments presented herein. The network controller 200 includes a processor 210 to process instructions relevant to the operations of the device, and memory 220 to store a variety of data and software instructions (e.g., network configurations, network element capabilities, etc.), including security logic 222 and network path selection logic 224. The network controller 200 also includes a network interface unit 230 configured to communicate with computing devices and network elements over a computer network. The computer network may include a wireless network, a wired network, a local area network, a wide area network, and/or other types of networks configured to communicate data between computing devices.

Memory 220 may include read only memory (ROM), random access memory (RAM), magnetic disk storage media devices, optical storage media devices, flash memory devices, electrical, optical, or other physical/tangible (e.g., non-transitory) memory storage devices. The processor 210 is, for example, a microprocessor or microcontroller that executes instructions for implementing the processes described herein. Thus, in general, the memory 220 may include one or more tangible (non-transitory) computer readable storage media (e.g., a memory device) encoded with software (e.g., the network path selection logic) comprising computer executable instructions and when the software is executed (by the processor 210) it is operable to perform the operations described herein.

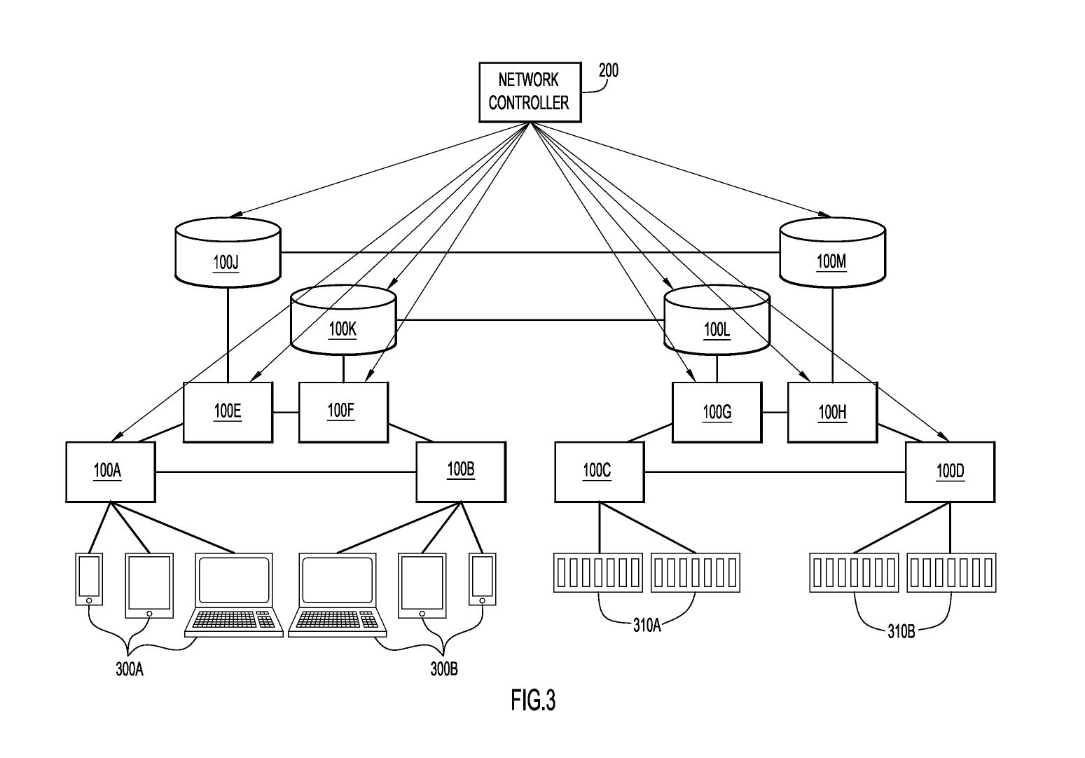

Referring now to FIG. 3, a communication network is shown with a plurality of endpoint devices (e.g., smart phones, tablet computers, laptop computers, desktop computers, servers, etc.) connected by a plurality of routers and switches. Network elements 100A, 100B, 100C, 100D, 100E, 100F, 100G, 100H, 100J, 100K, 100L, and 100M are network elements, such as switches and/or routers, which form a network. Communication links between the routers and switches allow for multiple traffic flow paths. A network controller 200 communicates with each of the network elements (e.g., routers, switches) and controls the traffic between a source endpoint and a sink endpoint. Endpoints 300A and 300B are user devices (e.g., smart phones, tablet computers, laptop computers) that may act as sources and sinks for communication flows. In this example, endpoints 300A and 300B initially connect to the computer network through network elements 100A and 100B, respectively. Endpoints 310A and 310B are enterprise servers that may act as sources or sinks for communication flows. In this example, endpoints 310A and 310B initially connect to the computer network through network elements 100C and 100D, respectively.

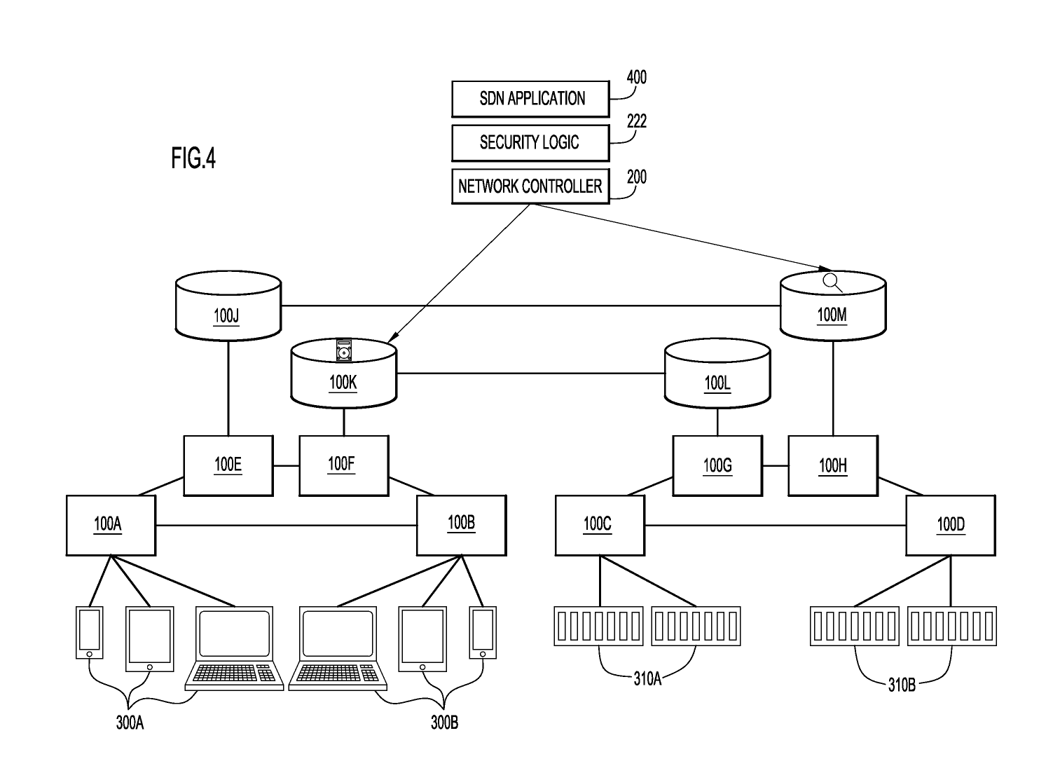

Referring now to FIG. 4, a SDN system with an SDN application 400 and security logic 222 are shown. In this example, network element 100K has the capability to record selected flows. Network element 100M has the capability to perform Deep Packet Inspection on selected flows. These network elements are shown separately in this example, but the functions may be combined in a single network element, and the capabilities of recording and/or inspecting may be duplicated in multiple network elements. Additionally, one or more network elements may have the capability to perform security enforcement activities on selected flows. The network controller 200 is aware of the topology of the network, and is aware of the location of the network security elements (i.e., elements 100K and 100M) within the network. In one example, the network controller 200 can control the security elements in addition to controlling the traffic flows that get directed to the network security elements.

Security logic 222 between the SDN application 400 and the network controller 200 may be implemented as part of the network controller 200, or as a separate module that is independent from the network controller 200. The security logic 222 accepts security requests from the SDN application(s) 400 and provides the network controller 200 with optimized instructions for directing the traffic flows in the network. The security logic 222 optimizes traffic flow such that the most, highest priority security requests get fulfilled within the capacity constraints of the communication links.

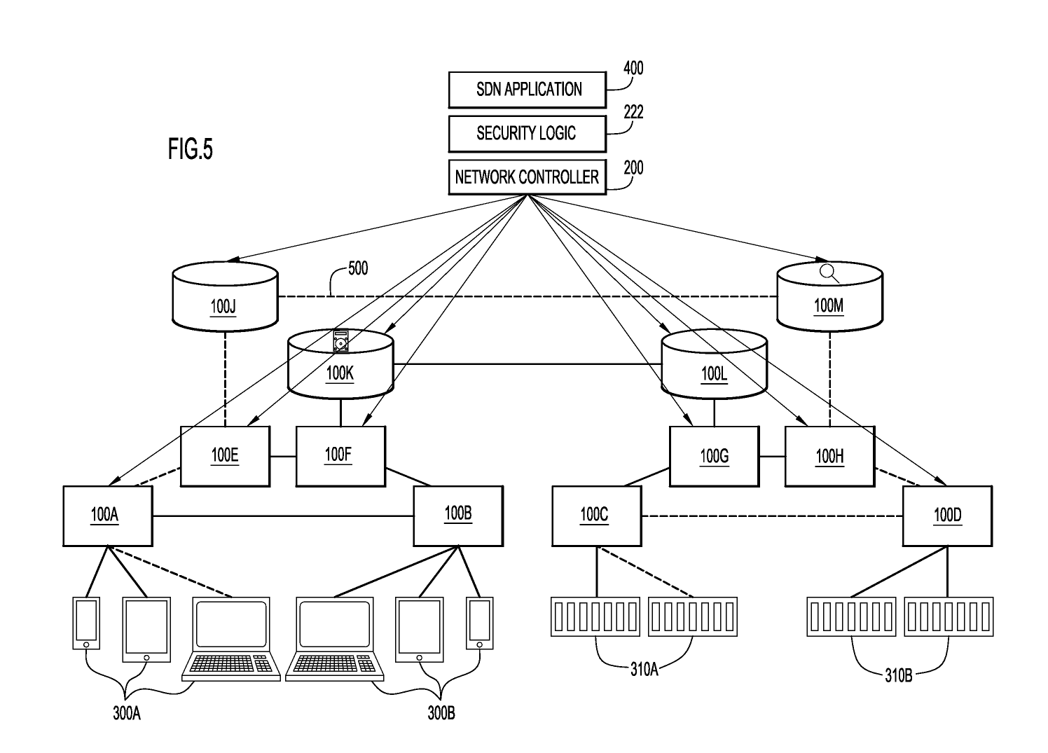

Referring now to FIG. 5, an example of a traffic flow that is directed through an inspection element is shown. The SDN application 400 sends a security request to the security logic 222 to direct traffic from a particular laptop endpoint 300A to a particular endpoint server 310A through an inspection element. The security logic 222 determines that this request is able to be fulfilled within the constraints of the network (e.g. the network links have sufficient capacity and the inspection element 100M has the processing capacity), and requests that the network controller 200 direct that particular data flow through the inspection element 100M. The network controller 200 directs traffic between the laptop 300A and the server 310A to pass through the network element 100M that has the inspection capability along network path 500. The inspection element 100M inspects the traffic in this particular data flow according to the security request.

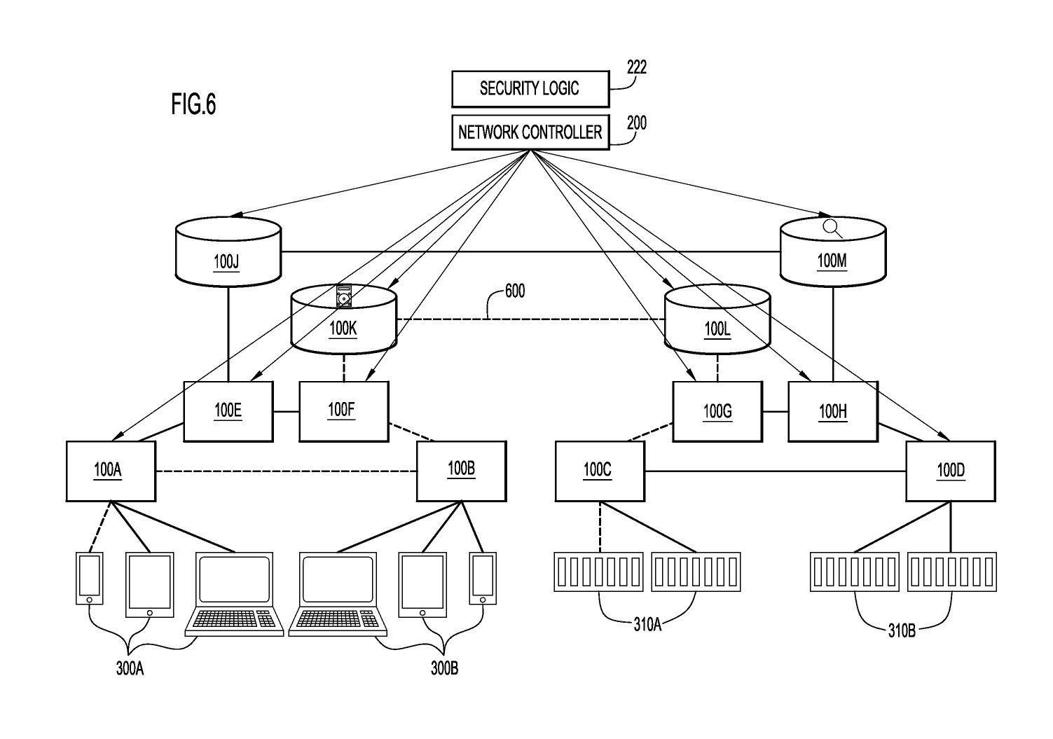

Referring now to FIG. 6, an example of a different traffic flow that is directed through a recording element is shown. The SDN application 400 (not shown in FIG. 6) sends a security request to the security logic 222 to direct traffic from a smart phone 300A to a server 310A through a recording element. The security logic 222 determines that this request is able to be fulfilled within the constraints of the network (e.g., network element 100K has sufficient processing capacity), and directs the network controller 200 to direct the traffic between the smart phone 300A and the server 310A to pass through the recording element 100K. The network controller 200 directs the traffic along network path 600, and the recording element 100K records the traffic in that data flow as requested in the security request.

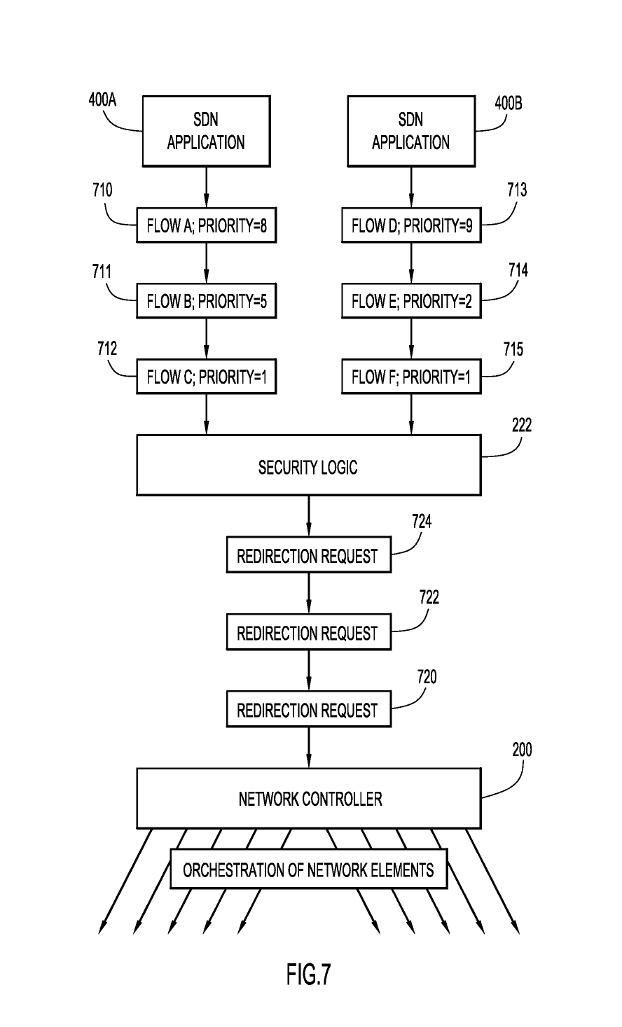

Referring now to FIG. 7, an example of two SDN applications making prioritized requests to the security logic 222 is shown. For example, SDN application 400A sends security request 710 for flow A with a high priority of 8, security request 711 for flow B with a medium priority of 5, and security request 712 for flow C with a low priority of 1. SDN application 400B sends security requests 713 for flow D with a high priority of 9, security request 714 for flow E with a relatively low priority of 2, and security request 715 for flow F with a low priority of 1. The security logic 222 processes all six security requests and develops redirection requests 720, 722, and 724 to send to the network controller 200. The network controller 200 receives the redirection requests and orchestrates the network elements to fulfill the security requests as best as possible.

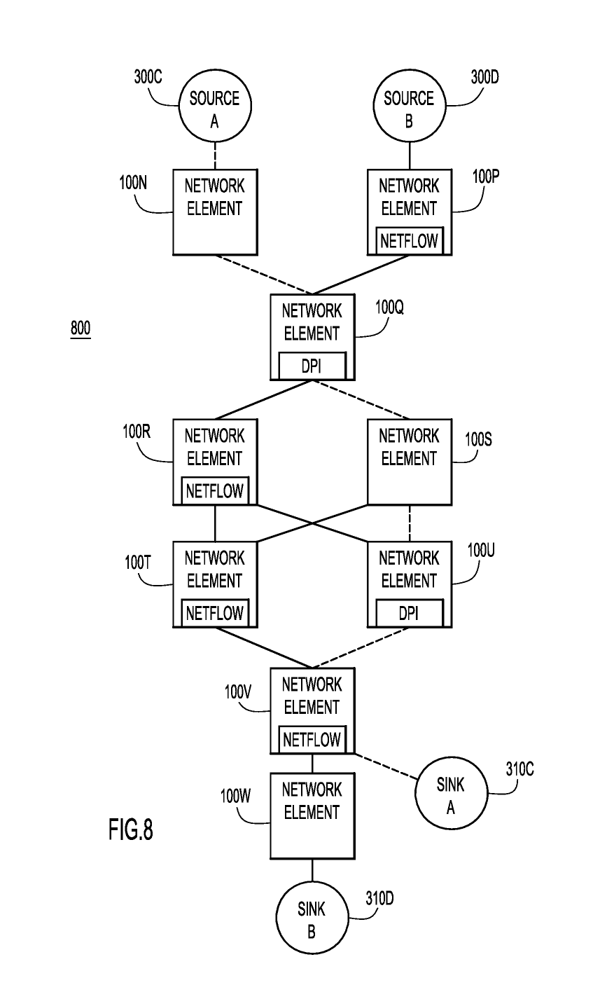

Referring now to FIG. 8, another example of a communication network with multiple switches and routers, as well as multiple security elements is shown. The network elements 100N, 100P, 100Q, 100R, 100S, 100T, 100U, 100V, and 100W are routers or switches. In this example, the network elements 100P, 100R, 100T, and 100V may include Netflow exporters and the network elements 100Q and 100U include Deep Packet Inspection (DPI) engines.

For a given network and set of security elements, it is possible and desirable to arrange the flow of traffic around the network so that each security element is best utilized. A flow that needs to be monitored should be passed through an element that can monitor that particular type of traffic, for instance. In general, there may be multiple security elements on a network that can perform a particular type of monitoring or enforcement, but it does not matter which element does the work as long as it is done. For example, in a communication flow between source endpoint 300C and sink endpoint 310C that uses the network path through both elements 100Q and 100U, either DPI element 100Q or 100U could perform monitoring of the communication flow. In general, there may be many flows on which security services are needed, and the flow of traffic should be arranged in a way that accommodates all of the needs, if possible, or a way that best accommodates them.

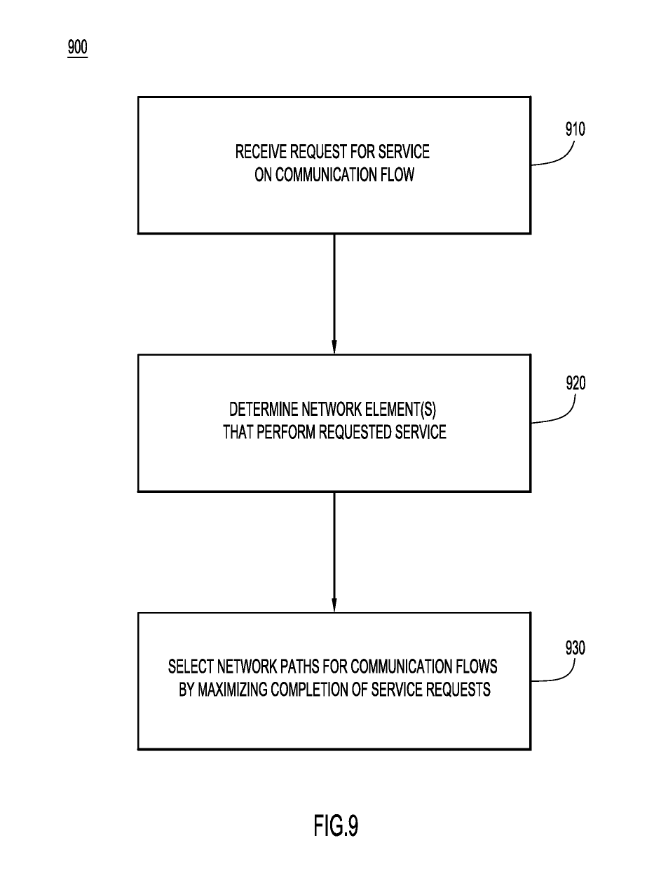

Referring now to FIG. 9, a flowchart is shown of an example process 900 of the operations of the security logic 222 in orchestrating the assignment of network paths for communication flows in a computer network. In step 910, one or more requests for service on a communication flow are received. In step 920, the network controller determines one or more network elements that can perform the requested service. The network controller selects network paths for completing at least one of the service requests in step 930. The network paths are selected for each communication flow such that a communication flow uses a network path that includes a network element that has been determined to perform the service requested in the at least one service request that is completed.

In one example, the requests comprise an indication of at least one service to perform, such as an inspection service, an enforcement service, and/or a recording service. Additionally, the requests may specify criteria to identify communication flows that are to be subject to the requested service. For example, a request may specify that all flows to or from a specific endpoint should be monitored with a DPI engine. In another example, a request may specify that flows between two specific endpoints should be recorded. In yet another example, a request may specify that any flows directed to a specific endpoint should be subject to a firewall service, but allow flows from that endpoint to bypass the firewall service.

In summary, the security logic provides the best security possible for a given set of resources. The inputs to this logic are: the set of network elements that provide security services, and the capabilities of those services, and a policy that expresses which flows should be subject to those services. When the policy specifies that a particular flow should be inspected, the policy should also assign a weighting that indicates the importance that the inspection take place, and the duration that the flow should be inspected. When a network element registers a security capability, such as Deep Packet Inspection, it should also provide an indication of the throughput at which it can support that service. The system logic should ensure that inspection capabilities are always being used, even when their use has not been requested.

In one form, a method is provided for orchestrating the assignment of communication flows to network paths by receiving one or more requests for one or more services related to communication flows in a computer network. Each of the requests includes an indication of a particular communication flow and an indication of a particular service to perform on the particular communication flow. At least one network element is determined to perform at least one of the requested services. Network paths are selected for each of the communication flows to complete at least one of the received requests. A particular network path is selected for each particular communication flow such that the particular network path includes a particular network element that has been determined to perform the particular service corresponding to at least one of the received requests.

In another form, an apparatus including a network interface unit and a processor is provided for orchestrating the assignment of communication flows to network paths. The network interface unit communicates with network elements in a computer network. The processor receives one or more requests for one or more services related to communication flows in the network. Each of the requests includes an indication of a particular communication flow and an indication of a particular service to perform on the particular communication flow. The processor determines at least one network element in the computer network that performs at least one of the requested services. The processor selects network paths for each of the communication flows to complete at least one of the received requests. The processor selects a particular network path for each particular communication flow such that the particular network path includes a particular network element that has been determined to perform the particular service corresponding to at least one of the requests.

In yet another form, a non-transitory computer readable medium is provided with computer executable instructions for causing a processor to orchestrate the assignment of communication flows to network paths. The instructions cause the processor to receive one or more requests for one or more services related to communication flows in the network. Each of the requests includes an indication of a particular communication flow and an indication of a particular service to perform on the particular communication flow. The instructions cause the processor to determine at least one network element in the computer network that performs at least one of the requested services. The instructions cause the processor to select network paths for each of the communication flows to complete at least one of the received requests. The instructions cause the processor to select a particular network path for each particular communication flow such that the particular network path includes a particular network element that has been determined to perform the particular service corresponding to at least one of the requests.

The above description is intended by way of example only. Various modifications and structural changes may be made therein without departing from the scope of the concepts described herein and within the scope and range of equivalents of the claims.

What is claimed is:

1. A method comprising:
receiving one or more requests for one or more services related to communication flows in a computer network, each of the one or more requests including an indication of a particular communication flow and an indication of a particular service to perform on the particular communication flow;
determining at least one network element in the computer network that performs at least one of the one or more services; and
selecting network paths for each of the communication flows to complete at least one of the one or more received requests by selecting a particular network path for each particular communication flow such that the particular network path includes a particular network element determined to perform the particular service corresponding to the at least one of the received requests.

2. The method of claim 1, wherein each of the one or more received requests includes an associated priority value, and selecting the network paths further comprises minimizing a metric based on associated priority values of the one or more received requests.

3. The method of claim 2, wherein selecting the network paths further comprises selecting network paths in decreasing order of priority for communication flows associated with a received request of the one or more received requests, and subsequently selecting network paths for communication flows not associated with a received request.

4. The method of claim 2, wherein each of the network elements is associated with an amount of bandwidth, and wherein the metric is further based on the amount of bandwidth in each of the network elements in each of the network paths.

5. The method of claim 4, wherein the amount of bandwidth associated with each of the network elements is an amount of bandwidth to perform one or more of the requested services.

6. The method of claim 4, wherein the metric corresponds to a cost associated with using the amount of bandwidth at each of the network elements in the corresponding network path weighted by any priority value of received requests that are completed using the corresponding network path.

7. The method of claim 6, wherein selecting the network paths comprises minimizing a total cost over all of the communication flows in the computer network.

8. The method of claim 2, wherein minimizing the metric comprises calculating a distance between network elements, and wherein the distance between network elements which have been determined to perform at least one of the one or more services has been calculated before receiving the one or more requests.

9. The method of claim 1, wherein the one or more services related to communication flows include one or more of a inspection service, a recording service, or an enforcement service.

10. An apparatus comprising:
a network interface unit to communicate with network elements in a computer network; and
a processor to:
receive one or more requests for one or more services related to communication flows in the computer network, each of the one or more requests including an indication of a particular communication flow and an indication of a particular service to perform on the particular communication flow;
determine at least one network element in the computer network that performs at least one of the one or more services; and
select network paths for each of the communication flows to complete at least one of the one or more received requests by selecting a particular network path for each particular communication flow such that the particular network path includes a particular network element determined to perform the particular service corresponding to the at least one of the received requests.

11. The apparatus of claim 10, wherein each of the one or more received requests includes an associated priority value, and the processor selects the network paths by minimizing a metric based on associated priority values of the one or more received requests.

12. The apparatus of claim 11, wherein each of the network elements is associated with an amount of bandwidth, and wherein the metric is further based on the amount of bandwidth in each of the network elements in each of the network paths.

13. The apparatus of claim 12, wherein the amount of bandwidth associated with each of the network elements is an amount of bandwidth to perform one or more of the requested services.

14. The apparatus of claim 12, wherein the metric corresponds to a cost associated with using the amount of bandwidth at each of the network elements in the corresponding network path weighted by any priority value of received requests that are completed using the corresponding network path.

15. The apparatus of claim 14, wherein the processor selects the network paths by minimizing a total cost over all of the communication flows in the computer network.

16. The apparatus of claim 10, wherein the one or more services related to communication flows include one or more of an inspection service, a recording service, or an enforcement service.

17. One or more computer readable non-transitory storage media encoded with software comprising computer executable instructions that when executed by a processor of a computing device, cause the processor to:
receive one or more requests for one or more services related to communication flows in the computer network, each of the one or more requests including an indication of a particular communication flow and an indication of a particular service to perform on the particular communication flow;
determine at least one network element in the computer network that performs at least one of the one or more services; and
select network paths for each of the communication flows complete at least one of the one or more received requests by selecting a particular network path for each particular communication flow such that the particular network path includes a particular network element determined to perform the particular service corresponding to the at least one of the received requests.

18. The computer readable storage media of claim 17, wherein each of the one or more received requests includes an associated priority value, and the computer executable instructions cause the processor to select the network paths by minimizing a metric based on associated priority values of the one or more received requests.

19. The computer readable storage media of claim 18, wherein each of the network elements is associated with an amount of bandwidth, and wherein the metric is further based on the amount of bandwidth in each of the network elements in each of the network paths.

20. The computer readable storage media of claim 19, wherein the amount of bandwidth associated with each of the network elements is an amount of bandwidth to perform one or more of the requested services.

21. The computer readable storage media of claim 19, wherein the metric corresponds to a cost associated with using the amount of bandwidth at each of the network elements in the corresponding network path weighted by any priority value of received requests that are completed using the corresponding network path.

22. The computer readable storage media of claim 21, wherein the computer executable instructions cause the processor to select the network paths by minimizing a total cost over all of the communication flows in the computer network.

23. The computer readable storage media of claim 17, wherein the one or more services related to communication flows include one or more of an inspection service, a recording service, or an enforcement service.
